(19) United States
(12) Patent Application Publication
(10) Pub. No.: US 2026/0208453 A1
(43) Pub. Date: Jul. 23, 2026

(54) TEXTILE-REINFORCED THERMOPLASTIC COMPOSITE MATERIAL AND METHOD FOR MANUFACTURING TEXTILE-REINFORCED THERMOPLASTIC COMPOSITE MATERIAL USING INJECTION MOLDING

(71) Applicant: KOREA INSTITUTE OF INDUSTRIAL TECHNOLOGY, Cheonan-si (KR)

(72) Inventors: Sunghee LEE, Seoul (KR); Kyunghwan YOON, Seoul (KR); Euichul JUNG, Seongnam-si (KR)

(21) Appl. No.: 19/136,272

(22) PCT Filed: Apr. 3, 2023
(86) PCT No.: PCT/KR2023/004446

§ 371 Date: Jun. 5, 2025

(30) Foreign Application Priority Data
Dec. 9, 2022 (KR) 10-2022-0171310
Dec. 9, 2022 (KR) 10-2022-0171440

(51) Int. Cl. B29C 70/46; B29C 45/14; B29C 70/08; B29C 70/22; B29C 70/30; B29C 70/54; B29K 101/12; B29K 105/08

(52) U.S. Cl. CPC B29C 70/467; B29C 45/14786; B29C 70/086; B29C 70/22; B29C 70/30; B29C 70/547; B29K 2101/12; B29K 2105/0845

(57) ABSTRACT

The present disclosure relates to a textile-reinforced thermoplastic composite material with an improved structure for elasticity, high structural stiffness, higher productivity and lower manufacturing cost. Additionally, the present disclosure relates to a method for manufacturing a textile-reinforced thermoplastic composite material using improved injection molding whereby the textile-reinforced thermoplastic composite material is manufactured by injection molding without thermoforming using an intermediate material or a prepreg.

### TECHNICAL FIELD

The present disclosure relates to a textile-reinforced thermoplastic composite material, and more particularly, to a textile-reinforced thermoplastic composite material with an improved structure for elasticity, high structural stiffness, higher productivity and lower manufacturing cost.

The present disclosure relates to a method for manufacturing a textile-reinforced thermoplastic composite material, and more particularly, to a method for manufacturing a textile-reinforced thermoplastic composite material using improved injection molding whereby the textile-reinforced thermoplastic composite material is manufactured by injection molding without thermoforming using an intermediate material or a prepreg.

### BACKGROUND ART

According to the existing method for manufacturing a textile fiber-reinforced thermoplastic composite material, as shown in FIG. 1, an intermediate material or a prepreg is commonly used in thermoforming due to high melting temperature and viscosity of a thermoplastic matrix, and because the method includes many fragmented processes, the fragmented processes and the thermoforming increase the production time and the cost of the composite material, making it difficult to enter the composite material market in various industrial sections.

To overcome these shortcomings, as shown in FIG. 2, forming textile-reinforced thermoplastic composite materials by injection molding has been proposed, but in the existing technology, a thermoplastic matrix is not properly impregnated into fiber reinforcement of a mesh structure, causing the exposure of the textile to the surface.

### RELATED LITERATURES

(Patent Literature 1) Korean Patent Publication No. 10-2016-0132294

(Patent Literature 2) Korean Patent No. 10-1868512

### DISCLOSURE

### Technical Problem

The present disclosure is designed to solve the above-described problems, and therefore the present disclosure is directed to providing a textile-reinforced thermoplastic composite material with elasticity and high structural stiffness by increasing the impregnation ratio of a thermoplastic resin into voids of reinforcements having a woven fabric structure.

The present disclosure is further directed to providing a textile-reinforced thermoplastic composite material for increasing productivity and reducing the manufacturing cost.

The present disclosure is further directed to providing a method for manufacturing a textile-reinforced thermoplastic composite material using injection molding whereby the textile-reinforced thermoplastic composite material is manufactured by injection molding without thermoforming using an intermediate material such as a prepreg, and a fiber reinforcement effect is maximized by increasing the impregnation ratio between the fibers and the matrix during injection molding.

### Technical Solution

To achieve the above-described objective, a textile-reinforced thermoplastic composite material of the present disclosure includes a pair of reinforcements each having a woven fabric structure to allow a molten resin to pass through, and positioned spaced apart from each other, facing each other; a pair of mesh structures each having a mesh-like structure corresponding to a woven frame of the reinforcement, and bonded to each reinforcement to form a layer; and a thermoplastic matrix formed by impregnation into a space between the pair of reinforcements, voids in the pair of reinforcements of the woven structure and voids in the pair of mesh structures of the mesh-like structure.

Preferably, each mesh structure is bonded to the reinforcement positioned adjacent to the mesh structure to form the layer, and is positioned at an outer side with respect to a center line between the pair of reinforcements.

Preferably, each reinforcement has the woven fabric structure in which ribbons portions extended in a direction are woven to form the voids between the adjacent ribbon portions, and each mesh structure includes a plurality of space forming portions that contact the ribbon portions spaced apart from each other with the voids interposed therebetween, and connection portions connecting the space forming portions.

Preferably, each space forming portion has a spherical shape to make a line contact with each ribbon portion.

Preferably, each space forming portion may have an ellipsoidal shape with a long axis and a short axis to make a line contact with each ribbon portion, the connection portion may be disposed on an extension line of the short axis, and a contact line between the space forming portion and the ribbon portion may be formed on an extension line of the long axis.

Preferably, the thermoplastic matrix is formed by impregnation into the space between the pair of reinforcements, the voids in the pair of reinforcements of the woven structure, and the voids in the pair of mesh structures of the mesh-like structure by injection molding.

Preferably, the mesh structure and the thermoplastic matrix are made of a same material.

To achieve the above-described objective, a method for manufacturing a textile-reinforced thermoplastic composite material using injection molding according to the present disclosure includes a placement step of placing a pair of reinforcements having a woven fabric structure to allow a molten resin to pass through and a pair of mesh structures having a mesh-like structure corresponding to a woven frame of each reinforcement in a mold, each spaced apart from each other, facing each other; and an injection molding step of injecting the molten resin which is a molten product of a thermoplastic matrix into the mold so as to impregnate into a space between the pair of reinforcements, voids in the pair of reinforcements of the woven structure, and voids in the pair of mesh structures of the mesh-like structure.

Preferably, the present disclosure further includes, before the placement step, a bonding step of stacking and bonding each reinforcement and each mesh structure.

Preferably, the bonding step includes bonding each mesh structure to the reinforcement positioned adjacent to the mesh structure to form a layer, such that each mesh structure is positioned at an outer side with respect to a center line between the pair of reinforcements.

Preferably, each reinforcement has the woven fabric structure in which ribbons portions extended in a direction are woven to form the voids between the adjacent ribbon portions, and each mesh structure includes a plurality of space forming portions that contact the ribbon portions spaced apart from each other with the voids interposed therebetween, and connection portions connecting the space forming portions, and the bonding step includes bonding the mesh structure to the reinforcement in a state in which each space forming portion of the mesh structure contacts each ribbon portion of the reinforcement in a one-to-one correspondence relationship.

Preferably, when each space forming portion has a spherical shape, in the bonding step, each ribbon portion of the reinforcement and the corresponding space forming portion of the mesh structure are in line contact with each other.

When each space forming portion has an ellipsoidal shape with a long axis and a short axis to make a line contact with each ribbon portion, the bonding step may include placing the mesh structure such that a connection portion of the mesh structure is disposed on an extension line of the short axis, and a contact line between the space forming portion and the ribbon portion is formed on an extension line of the long axis.

Preferably, when the mesh structure and the thermoplastic matrix are made of a same material, the injection molding step includes ensuring high bond strength with the molten resin which is the molten product of the thermoplastic matrix at an interface of the mesh structure.

### Advantageous Effects

The textile-reinforced thermoplastic composite material according to the present disclosure having the above-described configuration includes the thermoplastic matrix formed by impregnation into the reinforcement having the woven fabric structure combined with the mesh structure of the mesh-like structure, so that a large space for the thermoplastic matrix to cover the reinforcement may be formed by the mesh structure, thereby increasing the impregnation ratio of the thermoplastic matrix into the reinforcement and preventing the exposure of the reinforcement after composite material forming, resulting in improved structural stiffness and safety of products.

Furthermore, the textile-reinforced thermoplastic composite material according to the present disclosure may modify the type and placement of the reinforcement, the mesh structure and the thermoplastic matrix according to the product designer's needs such as purpose and mechanical properties, and can be used in components or parts made of composite materials requiring mass production, for example, high strength lightweight components for automobiles such as electric vehicle battery covers or drone body parts.

In addition, to increase the mechanical properties such as stiffness and strength of the final product, the mesh structure within the composite material may be placed in multilayers, and in the multilayered structure of the textile reinforcement, the textile reinforcement may be stacked in different directions for each layer on the basis of the yarn direction of the textile reinforcement, thereby reducing the directional dependence of the composite material.

The method for manufacturing the textile-reinforced thermoplastic composite material using injection molding according to the present disclosure having the above-described configuration is configured to place the mesh structure having the mesh-like structure corresponding to the woven frame in the mold together with the reinforcement of the woven fabric structure and inject the high-pressure thermoplastic molten resin, so that the molten resin is injected in a state in which the reinforcement is spaced apart from the mold cavity surface by using the mesh structure, and eventually, the molten resin spreads to the inner part (facing the center of the mold) of the reinforcement and also passes through the inner part and surrounds the outer part (facing the cavity surface) between the cavity surface and the reinforcement, thereby increasing the impregnation ratio of the thermoplastic matrix into the reinforcement, yielding the thermoplastic composite material with high fiber reinforcement effect.

Additionally, the method for manufacturing the textile-reinforced thermoplastic composite material according to the present disclosure does not include thermoforming, thereby reducing the time required to perform the forming process from a few tens of minutes down to a few minutes or less, and may choose the type and placement of the reinforcement, the mesh structure and the thermoplastic matrix according to the product designer's needs such as purpose and mechanical properties, thereby quickly fabricating components or parts made of composite materials requiring mass production, for example, high strength lightweight components for automobiles such as electric vehicle battery covers or drone body parts.

Furthermore, because the textile-reinforced thermoplastic composite material is manufactured by placing the reinforcement and the mesh structure in the mold before the injection molding step, the textile reinforcement and the mesh structure may be positioned in multiple layers to increase the mechanical properties such as stiffness and strength of the final product, and in the multilayered structure of the textile reinforcement, the textile reinforcement may be stacked in different directions for each layer on the basis of the yarn direction of the textile reinforcement, yielding the textile-reinforced thermoplastic composite material having less directional dependence.

### DESCRIPTION OF DRAWINGS

FIGS. 1 and 2 are diagrams illustrating the conventional problems.

FIGS. 3 and 4 are cross-sectional views illustrating a structure of a textile-reinforced thermoplastic composite material according to an embodiment of the present disclosure and a method for manufacturing the same.

FIG. 5 is an exploded perspective view showing a reinforcement and a mesh structure employed in an embodiment of the present disclosure.

FIG. 6 is a diagram illustrating a manufacturing process of an embodiment of the present disclosure.

FIG. 7 is an enlarged view of section A in FIG. 6.

FIG. 8 is a cross-sectional view of a textile-reinforced thermoplastic composite material according to another embodiment of the present disclosure.

FIGS. 9 to 12 are diagrams illustrating a multilayered structure of a textile-reinforced thermoplastic composite material according to still another embodiment of the present disclosure, its advantages and a method for manufacturing the same.

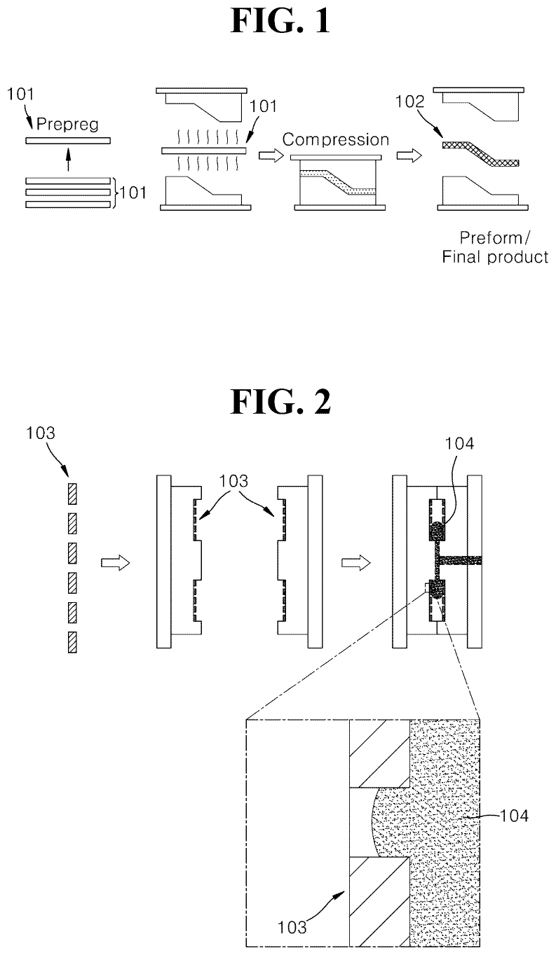

### BEST MODE

In the following description, for a clear understanding of the present disclosure, descriptions of known technology associated with the features of the present disclosure are omitted. The following embodiment provides a detailed description for helping the understanding of the present disclosure, and it is apparent that this is not intended to limit the scope of protection of the present disclosure. Accordingly, the equivalent invention that carries out the same function as the present disclosure will fall within the scope of protection of the present disclosure.

Furthermore, in the following description, the same reference sign indicates the same element, and unnecessary overlapping descriptions and descriptions of known technology are omitted. Additionally, the following description of each embodiment of the present disclosure that overlaps the description of the background art is omitted.

Hereinafter, a textile-reinforced thermoplastic composite material according to an embodiment of the present disclosure will be described in detail with reference to the accompanying drawings.

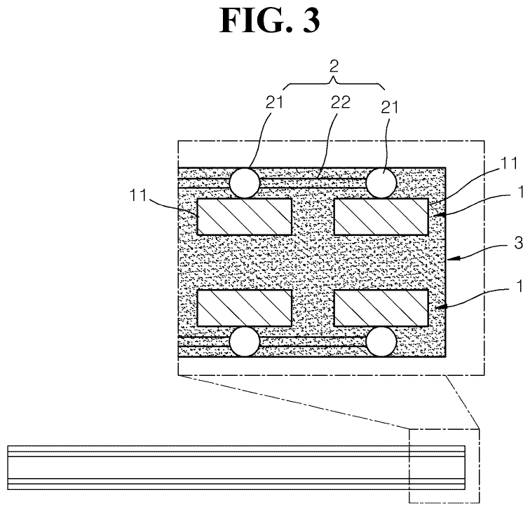

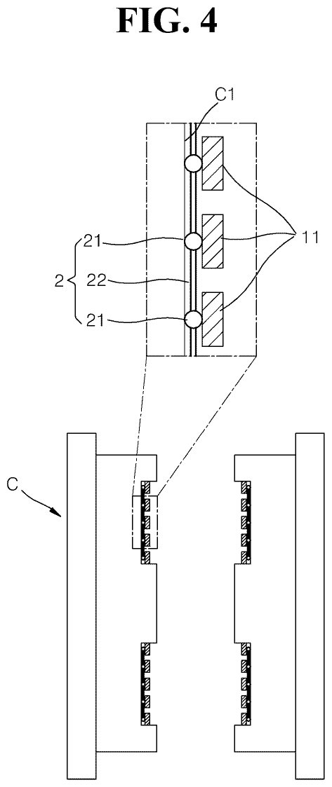

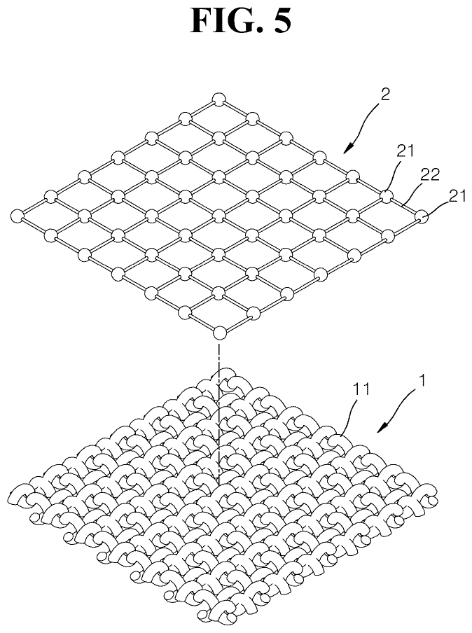

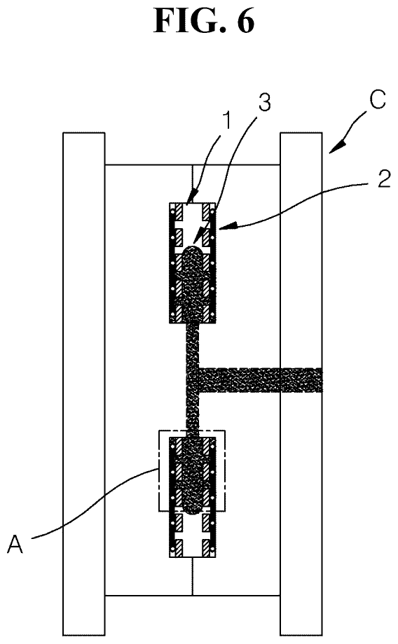

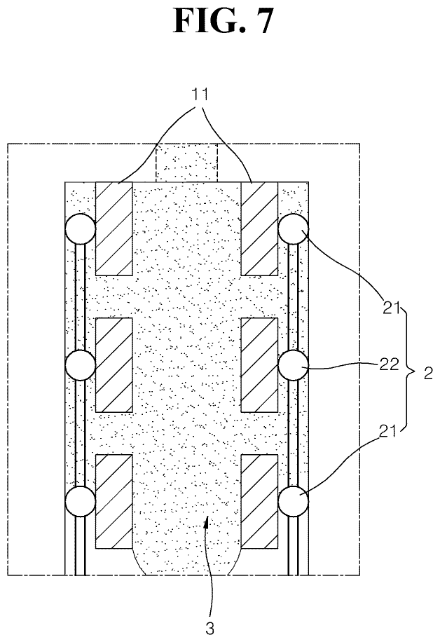

FIGS. 3 and 4 are cross-sectional views illustrating a structure of a textile-reinforced thermoplastic composite material according to an embodiment of the present disclosure and a method for manufacturing the same, FIG. 5 is an exploded perspective view showing a reinforcement and a mesh structure employed in an embodiment of the present disclosure, FIG. 6 is a diagram illustrating a manufacturing process of an embodiment of the present disclosure, and FIG. 7 is an enlarged view of section A in FIG. 6.

As shown in FIGS. 3 and 5, the textile-reinforced thermoplastic composite material according to an embodiment of the present disclosure is manufactured by holding a fiber material such as carbon fibers and a thermoplastic resin together to achieve high structural stiffness, and includes a pair of reinforcements 1 (including a ribbon portion 11) having a woven fabric structure, a pair of mesh structures 2 having a mesh-like structure, and a thermoplastic matrix 3 made of a thermoplastic material and formed by impregnation into voids of the reinforcements 1 and the mesh structures 2.

Each reinforcement 1 has the woven fabric structure to allow molten resin to pass through, and is positioned spaced apart from each other, facing each other. Each mesh structure 2 has the mesh-like structure corresponding to the woven frame of the reinforcement 1, and is bonded to each reinforcement 1 to form a layer.

Here, the reinforcement 1 may include various fiber materials, but preferably includes carbon fibers that are lighter than metal and has higher strength and elasticity than metal, and the mesh structure 2 may include a metal material such as aluminum or a thermoplastic resin material.

The thermoplastic matrix 3 includes a thermoplastic material, and is formed by impregnation into the space between the pair of reinforcements 1, the voids of the pair of reinforcements 1 of the woven structure and the voids of the pair of mesh structures 2 of the mesh-like structure.

The textile-reinforced thermoplastic composite material according to an embodiment of the present disclosure having the above-described configuration includes the thermoplastic matrix 3 formed by impregnation into the reinforcement 1 having the woven fabric structure combined with the mesh structure 2 of the mesh-like structure, so that a large space for the thermoplastic matrix 3 to cover the reinforcement 1 may be formed by the mesh structure 2, thereby increasing the impregnation ratio of the thermoplastic matrix 3 into the reinforcement 1 and preventing the exposure of the reinforcement 1 after composite material forming, resulting in improved structural stiffness and safety of products.

The impregnation of the thermoplastic matrix 3 into the reinforcement 1 and the mesh structure 2 may be done by various means, but as shown in FIGS. 4 and 6, injection molding is preferred to increase the manufacturing efficiency and the impregnation ratio.

According to injection molding commonly used to form composite materials, the reinforcement 1 made of fabrics is inserted into a mold C without the mesh structure 2 of the mesh-like structure and placed in contact with a mold cavity surface C1, and in this state, high-pressure molten resin is injected, and thus, the matrix in molten state is adequately impregnated into the inner part (facing the center of the mold) of the reinforcement 1 but poorly impregnated into the outer part (facing the mold cavity surface C1), failing to increase the fiber reinforcement effect.

However, by the injection molding method employed to realize an embodiment of the present disclosure, as shown in FIG. 4, the mesh structure 2 having the mesh-like structure corresponding to the woven frame is placed in the mold C together with the reinforcement 1 of the woven fabric structure, and as shown in FIG. 6, high-pressure thermoplastic molten resin is injected, and thus, the molten resin is injected in a state in which the reinforcement 1 is spaced apart from the mold C cavity surface C1 by using the mesh structure 2, and eventually, the molten resin spreads to the inner part of the reinforcement 1 (facing the center of the mold) and also passes through the inner part and surrounds the outer part (facing the cavity surface) between the cavity surface C1 and the reinforcement 1, thereby increasing the impregnation ratio of the thermoplastic matrix 3 into the reinforcement 1, so it is expected that it is possible to manufacture the thermoplastic composite material with high fiber reinforcement effect.

Each mesh structure 2 is bonded to the reinforcement 1 positioned adjacent to the mesh structure 2 to form a layer, and is preferably positioned at the outer side with respect to the center line between the pair of reinforcements 1.

That is, when forming the present embodiment by the injection molding method, the mesh structure 2 may be positioned at the inner side of the reinforcement 1 (facing the center of the mold), but is preferably positioned at the outer side of the reinforcement 1 (facing the mold cavity surface) to increase the impregnation ratio of the matrix into the reinforcement 1.

Each reinforcement 1 has the woven fabric structure in which ribbon portions 11 extended in a direction are woven to form voids between the adjacent ribbon portions 11, and each mesh structure 2 includes a plurality of space forming portions 21 that contact the ribbon portions 11 spaced apart from each other with the voids interposed between them, and connection portions 22 connecting the space forming portions 21.

In this embodiment having the above-described configuration, each space forming portion 21 of the mesh structure 2 is positioned in a one-to-one correspondence relationship with each ribbon portion 11 of the reinforcement 1 and the space forming portions 21 are connected to each other by the connection portion 22, thereby preventing the space forming portions 21 of the mesh structure 2 from being positioned in the voids of the reinforcement 1, and avoiding a decrease in structural stiffness caused by the factor that hinders the impregnation.

That is, the reinforcement 1 having the woven fabric structure has the voids between the adjacent ribbon portions 11, and when the space forming portions 21 of the mesh structure 2 are located in the voids, it fails to form a sufficient gap between the reinforcement 1 and the mold cavity surface C1, and accordingly, the reinforcement 1 and the mesh structure 2 are preferably bonded to each other such that the space forming portion 21 of the mesh structure 2 contacts each ribbon portion 11 of the reinforcement 1.

To minimize the factor that hinders the impregnation of the matrix into the reinforcement 1 by the contact between the space forming portion 21 and the ribbon portion 11, each space forming portion 21 is preferably in line contact with each ribbon portion 11. For the line contact, each space forming portion 21 may have a spherical shape as shown in FIG. 7.

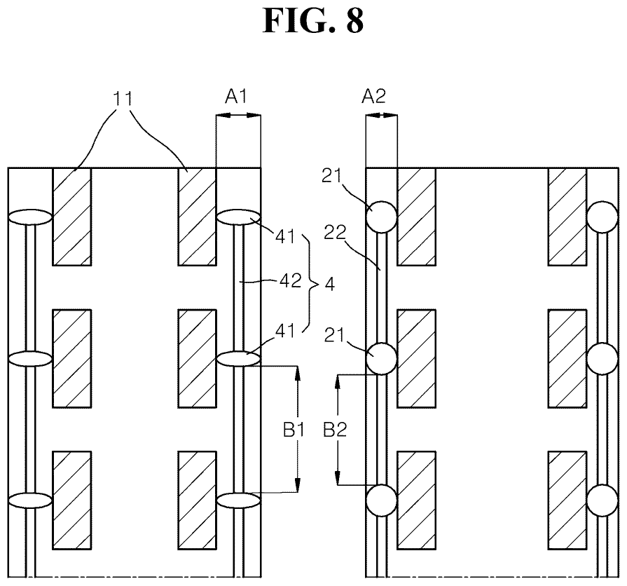

FIG. 8 is a cross-sectional view of the textile-reinforced thermoplastic composite material according to another embodiment of the present disclosure.

As shown in FIG. 8, when each space forming portion 41 has an ellipsoidal shape with a long axis and a short axis to make a line contact with each ribbon portion 11, preferably, the connection portion 42 is disposed on an extension line of the short axis and a contact line between the space forming portion 21 and the ribbon portion 11 is formed on an extension line of the long axis.

This embodiment having the above-described configuration may increase the space between the reinforcement and the mold cavity surface (A1>A2) through the portion that forms the long axis of the space forming portion 41 and minimize a reduction in space (B1>B2) through the portion that forms the short axis, thereby increasing the impregnation ratio of the matrix into the reinforcement.

When the mesh structures 2, 4 and the thermoplastic matrix 3 are made of the same material and the injection molding method is used in forming in this embodiment, this embodiment may significantly increase the bond strength of the molten resin that is the molten product of the thermoplastic matrix 3 at the interface of the mesh structures 2, 4, leading to very high fiber reinforcement effect, thereby significantly increasing the structural stiffness and safety of products.

Meanwhile, in addition to the above-described feature, the textile-reinforced thermoplastic composite material according to the present disclosure may modify the type and placement of the reinforcement, the mesh structure and the thermoplastic matrix according to the product designer's needs such as purpose and mechanical properties, and can be used in components or parts made of composite materials requiring mass production, for example, high strength lightweight components for automobiles such as electric vehicle battery covers or drone body parts.

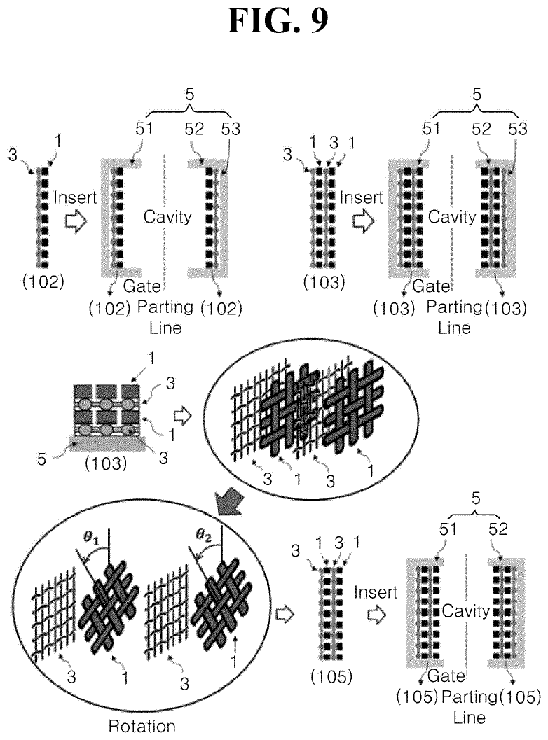

In addition, as shown in FIG. 9, to increase the mechanical properties such as stiffness and strength of the final product, the mesh structure within the composite material may be placed in multilayers, and in the multilayered structure of the textile reinforcement, the textile reinforcement may be stacked in different directions for each layer on the basis of the yarn direction of the textile reinforcement, thereby reducing the directional dependence of the composite material.

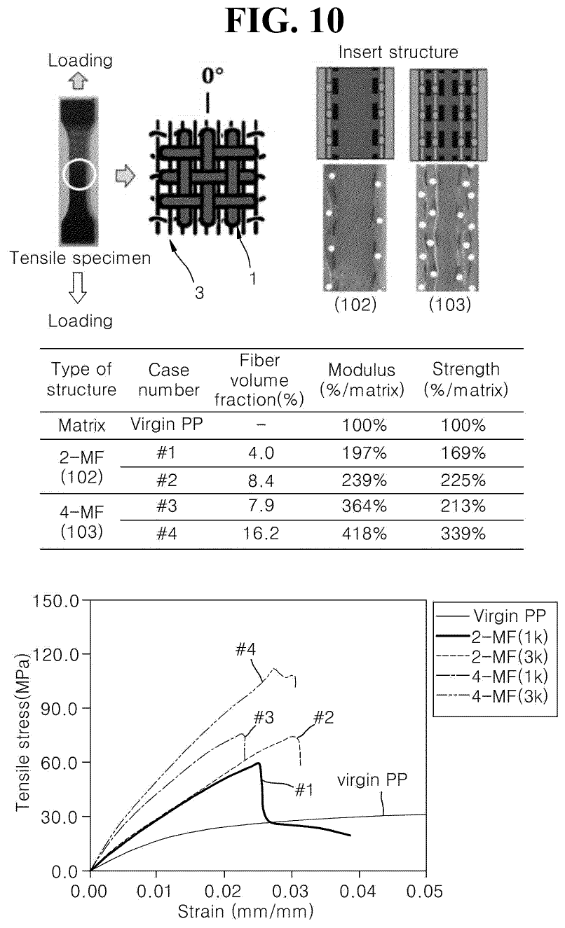

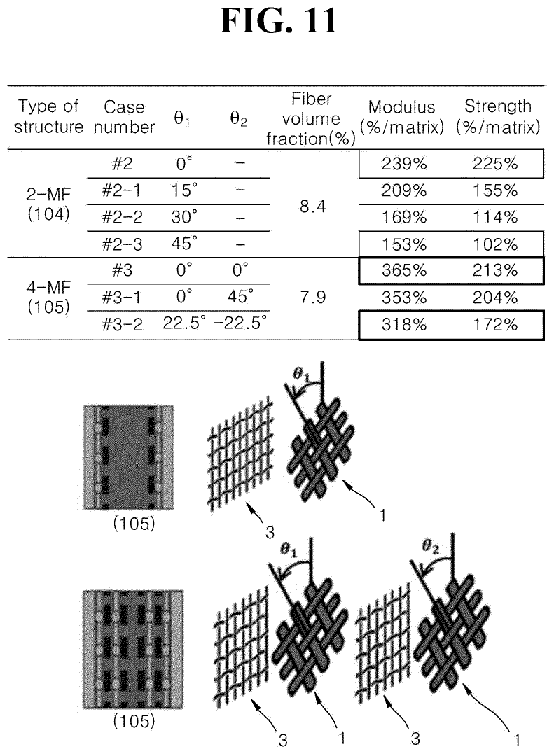

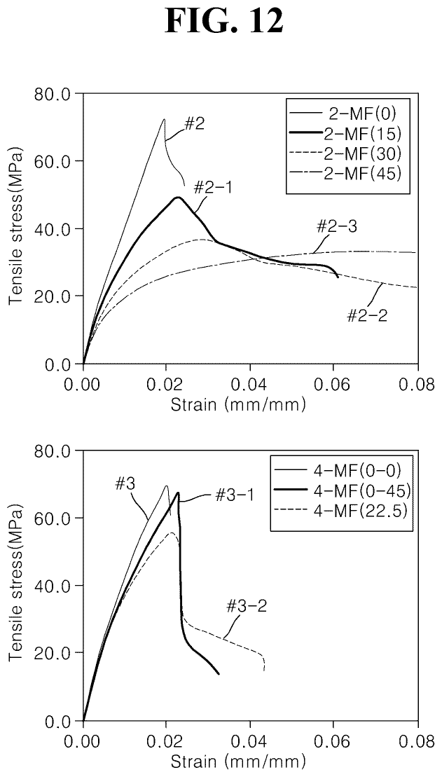

In this embodiment having the multilayered structure, as shown in FIG. 10, it is possible to obtain the reinforcement effect of 4.18-fold stiffness and 3.39-fold strength compared to the matrix, and as shown in FIG. 11 and FIG. 12, it is possible to improve the strength by stacking the reinforcement in varying directions, and reduce the directionality of the composite material.

Hereinafter, a method for manufacturing the textile-reinforced thermoplastic composite material using injection molding according to an embodiment of the present disclosure will be described in detail with reference to the accompanying drawings.

As shown in FIGS. 4 and 6, the method for manufacturing the textile-reinforced thermoplastic composite material using injection molding according to an embodiment of the present disclosure is designed to maximize the fiber reinforcement effect by injection molding without using a reinforcement method using an intermediate material such as a prepreg, and includes the placement step of placing the mesh structure 2 and the reinforcement 1 in the mold C and the injection molding step of injecting the molten resin that is the molten product of the thermoplastic matrix 3 into the mold C to form the composite material.

In the placement step, as shown in FIG. 4, the pair of reinforcements 1 having the woven fabric structure to allow the molten resin to pass through and the pair of mesh structures 2 having the mesh-like structure corresponding to the woven frame of each reinforcement 1 are placed in the mold C and positioned spaced apart from each other, facing each other.

The pair of reinforcements 1 and the pair of mesh structures 2 may be arranged sequentially in a chronological order within the mold C, but to achieve efficient forming, it is preferable to place the mesh structure 2 in a bonded state to each reinforcement 1.

Here, the molten resin includes a thermoplastic material and is in molten state so as to be injected into the mold C, the reinforcement 1 may include various fiber materials, but preferably includes carbon fibers that are lighter than metal and have higher strength and elasticity than metal, and the mesh structure 2 may include a metal material such as aluminum or a thermoplastic resin material.

In the injection molding step, as shown in FIG. 6, when the molten resin that is the molten product of the thermoplastic matrix 3 is injected into the mold C, the molten resin is impregnated into the space between the pair of reinforcements 1, the voids in the pair of reinforcements 1 of the woven structure and the voids in the pair of mesh structures 2 of the mesh-like structure.

According to injection molding commonly used to form composite materials, the reinforcement 1 made of fabrics is inserted into the mold C without the mesh structure 2 of the mesh-like structure and placed in contact with the mold cavity surface C1, and in this state, high-pressure molten resin is injected, and thus, the matrix in molten state is adequately impregnated into the inner part (facing the center of the mold) of the reinforcement 1 but poorly impregnated into the outer part (facing the mold cavity surface), failing to increase the fiber reinforcement effect.

However, according to the method for manufacturing the textile-reinforced thermoplastic composite material using injection molding according to an embodiment of the present disclosure, the mesh structure 2 having the mesh-like structure corresponding to the woven frame is placed in the mold C together with the reinforcement 1 of the woven fabric structure and the high-pressure thermoplastic molten resin is injected, and thus, the molten resin is injected in a state in which the reinforcement 1 is spaced apart from the mold cavity surface C1 by using the mesh structure 2, and eventually, the molten resin spreads to the inner part (facing the center of the mold) of the reinforcement 1 and also passes through the inner part and surrounds the outer part (facing the cavity surface) between the cavity surface C1 and the reinforcement 1, thereby increasing the impregnation ratio of the thermoplastic matrix 3 into the reinforcement 1, yielding the thermoplastic composite material with high fiber reinforcement effect.

As described above, the reinforcement 1 and the mesh structure 2 may be arranged sequentially in a chronological order within the mold C, but this embodiment further includes the bonding step before the placement step to increase forming efficiency.

That is, in the bonding step, the reinforcement 1 and the mesh structure 2 are bonded in a stacked state before each of them is placed in the mold C. The reinforcement 1 and the mesh structure 2 may be bonded by various bonding methods, for example, chemical bonding using an adhesive or physical joining by a mechanical mechanism, but a predetermined level of bond strength may be achieved by simple compression using the characteristics of the reinforcement 1 made of fibers without using chemical or physical bonding methods.

Additionally, in the bonding step, the mesh structure 2 is preferably bonded to the reinforcement 1 positioned adjacent to the mesh structure 2 to form a layer, and positioned at the outer side with respect to the center line between the pair of reinforcements 1.

That is, the mesh structure 2 may be positioned at the inner side of the reinforcement 1 (facing the center of the mold), but is preferably positioned at the outer side of the reinforcement 1 (facing the mold cavity surface) to increase the impregnation ratio of the matrix into the reinforcement 1.

Meanwhile, as shown in FIGS. 3 and 5, each reinforcement 1 employed to realize this embodiment has the woven fabric structure in which the ribbon portions 11 extended in a direction are woven to form voids between the adjacent ribbon portions 11, and each mesh structure 2 includes the plurality of space forming portions 21 that contact the ribbon portions 11 spaced apart from each other with the voids interposed between them, and the connection portions 22 connecting the space forming portions 21.

This embodiment is configured to increase the impregnation ratio by placing the mesh structure 2 at the outer side of the reinforcement 1 and stacking and bonding them in the bonding step, but to maximize the impregnation ratio, the reinforcement 1 and the mesh structure 2 are preferably bonded such that each space forming portion 21 of the mesh structure 2 contacts each ribbon portion 11 of the reinforcement 1 in a one-to-one correspondence relationship.

That is, the reinforcement 1 having the woven fabric structure has the voids between the adjacent ribbon portions 11, and when the space forming portions 21 of the mesh structure 2 are located in the voids, it fails to form a sufficient gap between the reinforcement 1 and the mold C cavity, and thus, the reinforcement 1 and the mesh structure are preferably bonded in a state in which the space forming portion 21 of the mesh structure 2 contacts each ribbon portion 11 of the reinforcement 1.

Meanwhile, to minimize the factor that hinders the impregnation of the matrix into the reinforcement 1 by the contact between the space forming portion 21 and the ribbon portion 11, as shown in FIG. 7, preferably, each space forming portion 21 has a spherical shape, and in the bonding step, the ribbon portion 11 and the corresponding space forming portion 21 of the mesh structure 2 are in line contact with each other.

While various embodiments of the present disclosure have been hereinabove described, these embodiments and the accompanying drawings are provided to clearly describe some of the technical spirit included in the present disclosure, and it is obvious that the scope of protection of the present disclosure covers all variations and specific embodiments that can be easily inferred by those skilled in the art within the technical spirit and scope included in the specification and drawings.

1. A textile-reinforced thermoplastic composite material comprising:
a pair of reinforcements each having a woven fabric structure to allow a molten resin to pass through, and positioned spaced apart from each other, facing each other;
a pair of mesh structures each having a mesh-like structure corresponding to a woven frame of the reinforcement, and bonded to each reinforcement to form a layer; and
a thermoplastic matrix formed by impregnation into a space between the pair of reinforcements, voids in the pair of reinforcements of the woven structure and voids in the pair of mesh structures of the mesh-like structure.

2. The textile-reinforced thermoplastic composite material according to 1,
wherein each mesh structure is bonded to the reinforcement positioned adjacent to the mesh structure to form the layer, and is positioned at an outer side with respect to a center line between the pair of reinforcements.

3. The textile-reinforced thermoplastic composite material according to 1,
wherein each reinforcement has the woven fabric structure in which ribbons portions extended in a direction are woven to form the voids between the adjacent ribbon portions, and
wherein each mesh structure includes a plurality of space forming portions that contact the ribbon portions spaced apart from each other with the voids interposed therebetween, and connection portions connecting the space forming portions.

4. The textile-reinforced thermoplastic composite material according to claim 3,
wherein each space forming portion has a spherical shape to make a line contact with each ribbon portion.

5. The textile-reinforced thermoplastic composite material according to claim 3,
wherein each space forming portion has an ellipsoidal shape with a long axis and a short axis to make a line contact with each ribbon portion, the connection portion is disposed on an extension line of the short axis, and a contact line between the space forming portion and the ribbon portion is formed on an extension line of the long axis.

6. The textile-reinforced thermoplastic composite material according to

3.
wherein the thermoplastic matrix is formed by impregnation into the space between the pair of reinforcements, the voids in the pair of reinforcements of the woven structure, and the voids in the pair of mesh structures of the mesh-like structure by injection molding.

7. The textile-reinforced thermoplastic composite material according to claim 1,
wherein the mesh structure and the thermoplastic matrix are made of a same material.

8. The textile-reinforced thermoplastic composite material according to claim 1,
wherein each reinforcement and each mesh structure are stacked and positioned with a multilayer structure in an alternating manner.

9. The textile-reinforced thermoplastic composite material according to 8,
wherein the reinforcements of the multilayer structure are stacked in different directions for each layer on a yarn direction basis.

10. A method for manufacturing a textile-reinforced thermoplastic composite material using injection molding, the method comprising:
a placement step of placing a pair of reinforcements having a woven fabric structure to allow a molten resin to pass through and a pair of mesh structures having a mesh-like structure corresponding to a woven frame of each reinforcement in a mold, each spaced apart from each other, facing each other; and
an injection molding step of injecting the molten resin which is a molten product of a thermoplastic matrix into the mold so as to impregnate into a space between the pair of reinforcements, voids in the pair of reinforcements of the woven structure, and voids in the pair of mesh structures of the mesh-like structure.

11. The method for manufacturing the textile-reinforced thermoplastic composite material using injection molding according to claim 10, further comprising:
before the placement step,
a bonding step of stacking and bonding each reinforcement and each mesh structure.

12. The method for manufacturing the textile-reinforced thermoplastic composite material using injection molding according to claim 11,
wherein the bonding step comprises bonding each mesh structure to the reinforcement positioned adjacent to the mesh structure to form a layer, such that each mesh structure is positioned at an outer side with respect to a center line between the pair of reinforcements.

13. The method for manufacturing the textile-reinforced thermoplastic composite material using injection molding according to claim 11,
wherein each reinforcement has the woven fabric structure in which ribbons portions extended in a direction are woven to form the voids between the adjacent ribbon portions, and each mesh structure includes a plurality of space forming portions that contact the ribbon portions spaced apart from each other with the voids interposed therebetween, and connection portions connecting the space forming portions, and
wherein the bonding step comprises bonding the mesh structure to the reinforcement in a state in which each space forming portion of the mesh structure contacts each ribbon portion of the reinforcement in a one-to-one correspondence relationship.

14. The method for manufacturing the textile-reinforced thermoplastic composite material using injection molding according to claim 13,
wherein when each space forming portion has a spherical shape,
in the bonding step, each ribbon portion of the reinforcement and the corresponding space forming portion of the mesh structure are in line contact with each other.

15. The method for manufacturing the textile-reinforced thermoplastic composite material using injection molding according to claim 13,
wherein when each space forming portion has an ellipsoidal shape with a long axis and a short axis to make a line contact with each ribbon portion,
the bonding step comprises placing the mesh structure such that a connection portion of the mesh structure is disposed on an extension line of the short axis, and a contact line between the space forming portion and the ribbon portion is formed on an extension line of the long axis.

16. The method for manufacturing the textile-reinforced thermoplastic composite material using injection molding according to claim 10,
wherein when the mesh structure and the thermoplastic matrix are made of a same material,
the injection molding step comprises ensuring high bond strength with the molten resin which is the molten product of the thermoplastic matrix at an interface of the mesh structure.

17. The method for manufacturing the textile-reinforced thermoplastic composite material using injection molding according to claim 10,
wherein each reinforcement and each mesh structure are stacked and positioned with a multilayer structure in an alternating manner.

18. The method for manufacturing the textile-reinforced thermoplastic composite material using injection molding according to claim 17,
wherein the reinforcements of the multilayer structure are stacked in different directions for each layer on a yarn direction basis.
